(19) United States
(12) Patent Application Publication
(10) Pub. No.: US 2014/0078390 A1
(43) Pub. Date: Mar. 20, 2014

(54) FIELD CONVERSIONS TO SLOWER VIDEO RATES

(71) Applicant: BROADCOM CORPORATION, Irvine, CA (US)

(72) Inventors: Jason HERRICK, Pleasanton, CA (US); Richard Hayden WYMAN, Sunnyvale, CA (US)

(73) Assignee: BROADCOM CORPORATION, Irvine, CA (US)

(21) Appl. No.: 13/623,827

(22) Filed: Sep. 20, 2012

(51) Int. Cl. H04N 7/01

(52) U.S. Cl. 348/441; 348/E07.003

(57) ABSTRACT

Systems and methods are provided for converting an interlaced video to a slower video rate. A method for video rate conversion may include receiving an input interlaced video having a field rate, and deinterlacing the input interlaced video at the field rate to produce a first sequence of frames corresponding to a first frame rate. The method may also include dropping frames from the first sequence of frames to produce a second sequence of frames corresponding to a second frame rate, wherein the second frame rate is slower than the first frame rate. If a progressive video output is desired, then the second sequence of frames may be used for the progressive video output. If an interlaced video output is desired, then the second sequence of frames may be interlaced into a sequence of fields corresponding to a field rate slower than the field rate of the input interlaced video.

### TECHNICAL FIELD

The present description relates generally to video processing, including field conversions to slower video rates.

### BACKGROUND

Interlaced video alternately displays two different types of fields on a display, where each type of field may include approximately half the horizontal lines of a full image. For example, one type of field may include odd-numbered lines and the other type of field may include even-numbered lines. Progressive video sequentially displays frames on a display, where each frame may be a full image.

Interlaced video recorded at a particular field rate may be converted to interlaced video at a different field rate or progressive video at a different frame rate. For example, a user may want to view interlaced video recorded at 60 fields per second (60i) on a display configured to display interlaced video (e.g., PAL video) at 50 fields per second (50i) or progressive video at 50 frames per second (50p).

### BRIEF DESCRIPTION OF THE DRAWINGS

Certain features of the subject technology are set forth in the appended claims. However, for purpose of explanation, several embodiments of the subject technology are set forth in the following figures.

FIG. 1A illustrates an example of a system for converting interlaced video to a slower video rate.

FIG. 1B illustrates an example of field conversion for the system in FIG. 1A.

FIG. 2A illustrates an example of another system for converting interlaced video to a slower video rate.

FIG. 2B illustrates an example of field conversion for the system in FIG. 2A.

FIG. 3A illustrates an example system for converting interlaced video to a slower video rate according to an aspect of the subject technology.

FIG. 3B illustrates an example of field conversion for the system in FIG. 3A according to an aspect of the subject technology.

FIG. 4A illustrates an example system for converting interlaced video to a slower video rate according to another aspect of the subject technology.

FIG. 4B illustrates an example of field conversion for the system in FIG. 4A according to an aspect of the subject technology.

FIG. 5 illustrates an example system for converting interlaced video to a slower video rate according to still another aspect of the subject technology.

FIG. 6 illustrates an example system for converting interlaced video to a slower video rate according to yet another aspect of the subject technology.

FIG. 7 illustrates an example of field conversion for interlaced video generated using a 3:2 pull-down process according to an aspect of the subject technology.

FIG. 8 illustrates an example process for converting interlaced video to a slower video rate according to an aspect of the subject technology.

FIG. 9 conceptually illustrates an example electronic system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without one or more of the specific details. In some instances, structures and components are shown in block diagram form in order to avoid obscuring the concepts of the subject technology.

In this disclosure, the term “video rate” may refer to a field rate for interlaced video or a frame rate for progressive video. For example, a video rate of 50 Hz may refer to a field rate of 50i for interlaced video or a frame rate of 50p for progressive video. Aspects of the subject technology provide systems and methods for converting interlaced video to a slower video rate, as discussed further below.

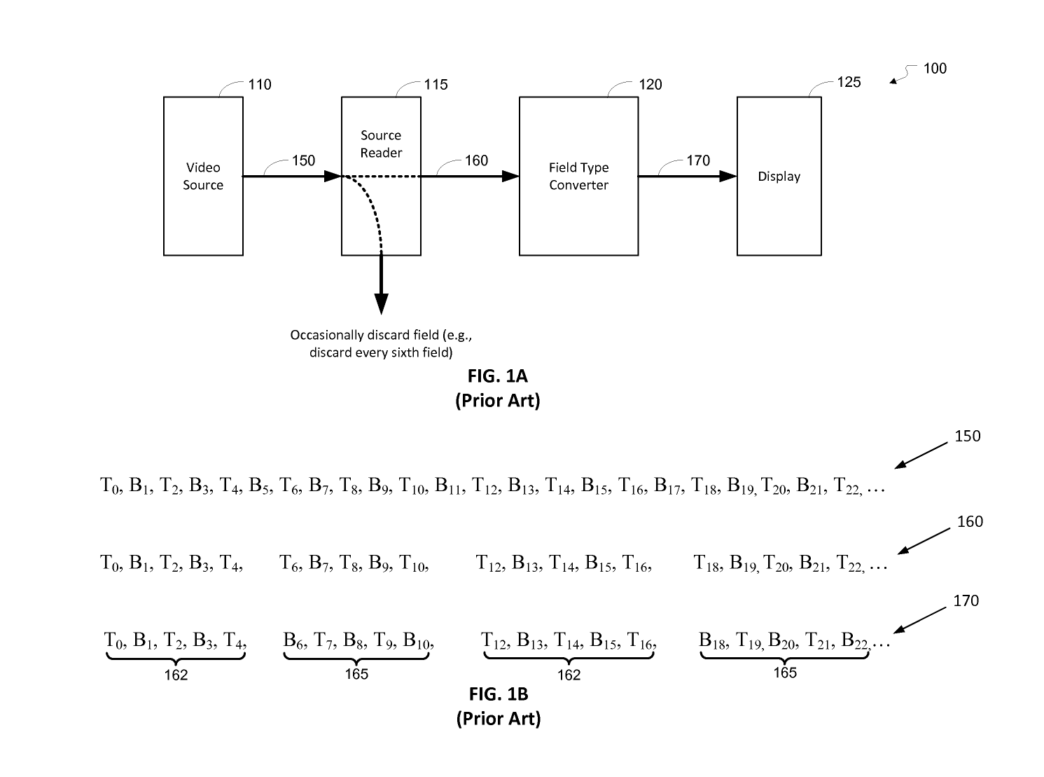

FIG. 1A illustrates an example system 100 for converting interlaced video to a slower video rate. The system 100 receives interlaced video from a video source 110. The input interlaced video may include a sequence of fields 150 shown in FIG. 1B, where T denotes a top field and B denotes a bottom field. As shown in FIG. 1B, the sequence 150 alternates between T and B fields. A T field may be made up of odd-numbered lines and a B field may be made up of even-numbered lines.

The system 100 may include a source reader 115 that converts the input interlaced video to a slower field rate by occasionally (e.g., periodically) dropping a field from the input interlaced video. For example, the source reader 115 may convert the field rate of the input video from 60i to 50i by dropping every sixth field in the input video. An example of this is shown in FIG. 1B, in which the field sequence 150 of the input video is converted to a slower-rate field sequence 160 by dropping every sixth field (B₅, B₁₁, B₁₇, . . . ).

The alternating pattern of T and B fields (alternating cadence) in the field sequence 150 of the input video is not preserved in the slower-rate field sequence 160 due to dropping a number of the fields. For example, the slower-rate field sequence 160 has pairs of adjacent T fields (e.g., T₄ and T₆), as shown in the example in FIG. 1B. As a result, if a progressive video output is desired, a deinterlacer cannot be used on the slower-rate field sequence 160 because the alternating cadence is lost. Further, even if an interlaced video output is desired, field type conversion of the slower-rate field sequence 160 may be required to restore the alternating cadence.

To this end, the system 100 may include a field type converter 120 that converts the slower-rate field sequence 160 into a slower-rate field sequence 170 with alternating T and B fields. The field type converter 120 may achieve this by performing field type conversion on every other set of five fields in the sequence 160. In the example in FIG. 1B, field sets 162 are unconverted, while field sets 165 are converted to restore the alternating cadence. Within the converted field sets, each T field is converted to a B field and each B field is converted to a T field (e.g., using a video scaler). However, the field type conversion may result in a regular vertical “bouncing” effect between the converted and unconverted field sets when viewed on a display 125 (e.g., operating at a video rate of 50 Hz).

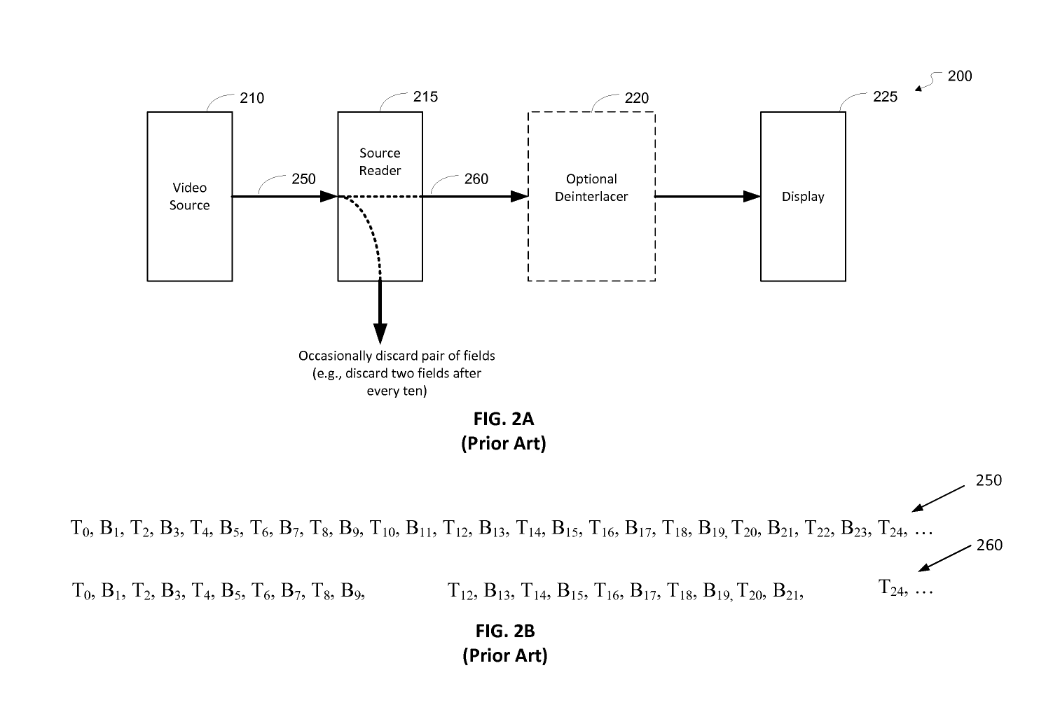

FIG. 2A illustrates another example system 200 for converting interlaced video to a slower video rate. The system 100 receives interlaced video from a video source 210. The input interlaced video may be a sequence of fields 250 having alternating T and B fields, as shown in FIG. 2B.

The system 200 may include a source reader 215 that converts the field rate of the input interlaced video from 60i to 50i by dropping a pair of adjacent fields after every ten fields. This results in the slower-rate field sequence 260 shown in FIG. 2B, in which two adjacent fields (e.g., T₁₀ and B₁₁) are dropped after every ten fields. If an interlaced video output is desired, then the slower-rate field sequence 260 may be viewed on a display 225 (e.g., operating at a video rate of 50 Hz). If a progressive video output is desired, then the fields in the slower-rate field sequence 260 may be converted into frames using a deinterlacer 220 before display on the display 225.

By dropping pairs of adjacent fields, the alternating cadence is preserved and the system 200 avoids the “bouncing” effect associated with system 100. However, the missing pairs of fields in the output may result in a noticeable loss of temporal resolution. For example, when the video pans a scene from left to right, a viewer may notice regular jumps in the motion of the video corresponding to the missing pairs of fields.

Additionally, in the system 200, the deinterlacer 220 may not be able to properly deinterlace certain video content. For example, an input interlaced video having a field rate of 60i may have been generated from film having a frame rate of 24 fps using a 3:2 pull-down process. This results in the fields of the input interlaced video having a known repetitive pattern. A deinterlacer can properly deinterlace the fields in the input video using a reverse 3:2 process based on the known repetitive pattern. However, dropping pairs of adjacent fields breaks the repetitive pattern in the input video. As a result, the repetitive pattern is not preserved in the slower-rate field sequence 260 and the deinterlacer 220 may not be able to properly deinterlace the slower-rate field sequence 260.

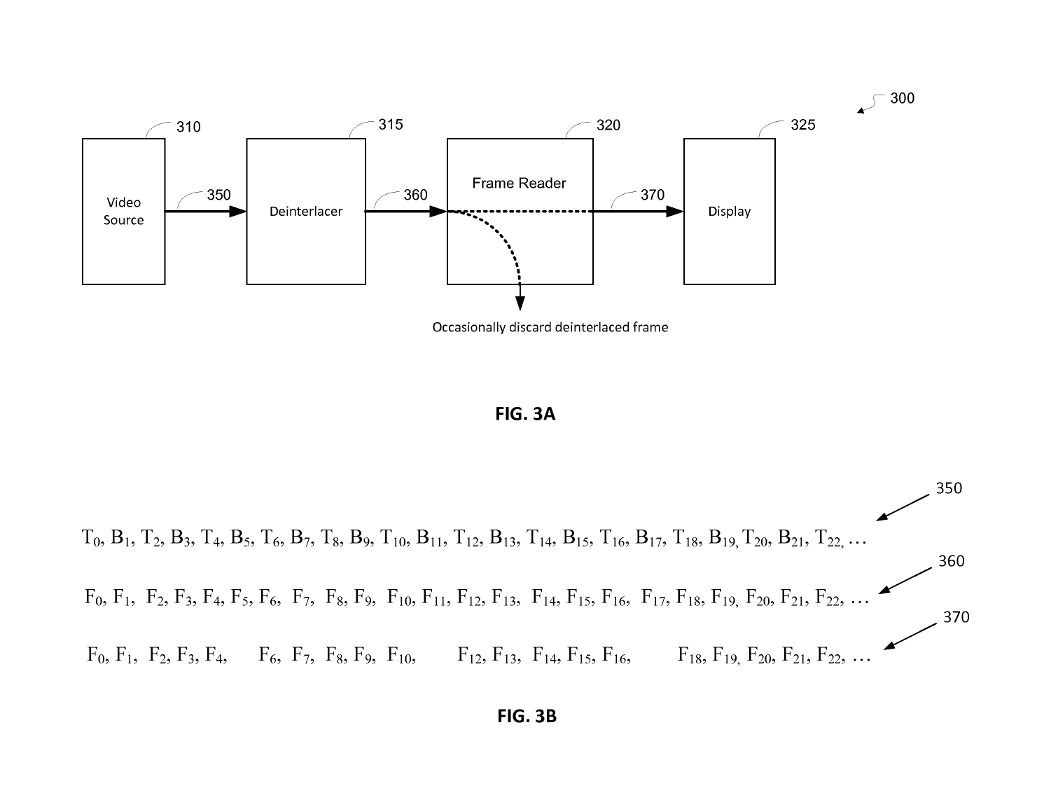

FIG. 3A shows an example system 300 for converting interlaced video to a slower video rate according to an aspect of the subject technology. The system 300 deinterlaces input interlaced video from a video source 310 at the field rate of the input interlaced video. As result, the system 300 does not drop fields in the input interlaced video and therefore avoids the “bouncing” effect and loss of temporal resolution associated with the above-mentioned systems. The system 300 achieves rate conversion after deinterlacing by dropping some of the deinterlaced frames, as discussed further below.

The system 300 receives interlaced video from the video source 310. The video source may be a cable input (e.g., when the system 300 is implemented in a set top box), a wireless input, a memory, or other source. The interlaced video from the video source 310 may include a sequence of fields 350 having alternating T and B fields, as shown in FIG. 3B.

The system 300 may include a deinterlacer 315 operating at the rate of the video source 310 (the field rate of the input interlaced video). For example, if the input interlaced video has a field rate of 60i, then the deinterlacer 315 operates at a video rate of 60 Hz. The deinterlacer 315 deinterlaces the fields in the input interlaced video to produce a corresponding sequence of frames. For example, the deinterlacer 315 may process multiple fields in the input interlaced video within a moving window to produce each frame. The number of fields used to produce a frame may vary, for example, depending on the deinterlacing algorithm employed by the deinterlacer 315. Because the deinterlacer 315 operates at the same rate as the input interlaced video, the deinterlacer 315 can use all of the fields of the input interlaced video, resulting in high-quality frames.

As used in this disclosure, the term “deinterlacer” may cover any device that converts incoming fields into frames. In other words, the term “deinterlacer” may cover any device that receives fields as input and outputs frames, where one or more of the input fields may be used to produce an output frame. Any suitable type of deinterlacer may be used with the subject technology, including, but not limited to, a motion adaptive deinterlacer and/or a motion compensated deinterlacer.

FIG. 3B shows an example of a sequence of frames 360 produced by the deinterlacer 315. In this example, the frame rate of the frame sequence 360 is the same as the field rate of the input interlaced video. For example, if the input interlaced video has a field rate of 60i, then the frame sequence 360 may have a frame rate of 60p. In this example, the number of frames equals the number of fields in the input interlaced video.

The system 300 may also include a frame reader 320 that converts the deinterlaced frame sequence 360 output from the deinterlacer 315 to a slower rate by occasionally (e.g., periodically) dropping or discarding one or more frames from the frame sequence 360. For example, the frame reader 320 may reduce the frame rate from 60p to 50p by dropping every sixth frame from the frame sequence 360, resulting in the slower-rate frame sequence 370, shown in FIG. 3B. Thus, the rate conversion in system 300 occurs at the frame reader 320 after deinterlacing. The frame reader 320 may include a buffer capable of storing multiple frames at a time and may output the frames in the frame sequence 370 at the slower rate (e.g., output a frame every 1/50 of a second for a rate of 50 Hz).

Dropping frames in system 300 does not result in the same degradation of video quality as the dropping of fields from the source video, e.g., as performed in systems 100 and 200. As discussed above, each frame from the deinterlacer 315 is produced by processing multiple fields in the input interlaced video within a moving window. Thus, the information in each field may contribute to two or more frames in the output of the deinterlacer 315. As a result, when a frame is dropped from the frame sequence 360, one or more other frames in the sequence 360 may contain the same field information. Thus, dropping frames may result in little or no loss of field information from the source video. If a progressive video output is desired, then the fields in the slower-rate frame sequence 370 may be displayed on a display 325 at the slower rate (e.g., a display operating at a video rate of 50 Hz).

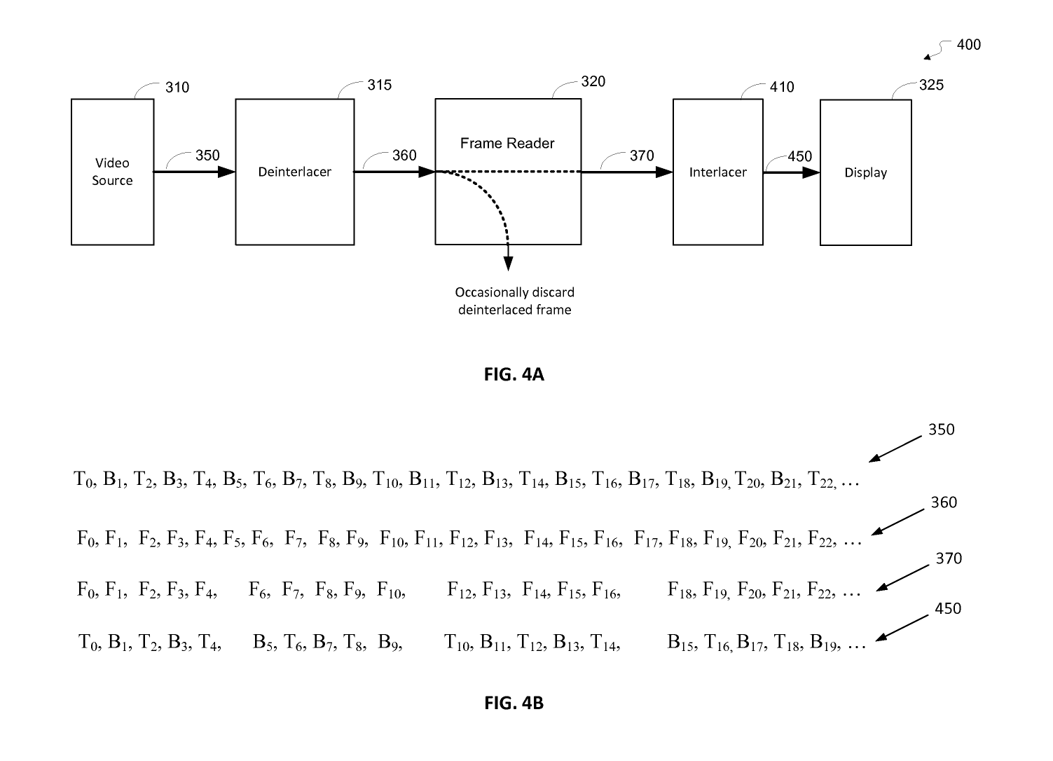

If an interlaced video output is desired (e.g., at a field rate of 50i), then the frames in the frame sequence 370 may be interlaced by an interlacer to convert the frames into fields at the slower rate (e.g., at a rate of 50i). FIG. 4A illustrates an example system 400 that includes an interlacer 410 operating at the slower rate (e.g., 50 Hz). The interlacer 410 receives the frame sequence 370 from the frame reader 320 and converts the frame sequence 370 into an interlaced sequence 450 of alternating B and T fields at the slower rate, as shown in FIG. 4B. In this example, the input interlaced video has a field rate of 60i, which is reduced to a field rate of 50i at the output of the interlacer 410. Thus, FIG. 4B illustrates an example of 60i to 50i conversion.

Although aspects of the subject technology are described above using the examples of 60i to 50i conversion or 60i to 50p conversion, it is to be appreciated that the subject technology is not limited to these examples, and may be used in any application where it is desirable to convert interlaced video to a slower video rate (i.e., a slower field rate for an interlaced video output or a slower frame rate for a progressive video output). The number of frames that are dropped for a given number of deinterlaced frames may depend on a desired amount of rate reduction. For example, fewer deinterlaced frames may be dropped for a smaller amount of rate reduction while more deinterlaced frames may be dropped for a larger amount of rate reduction.

In one aspect, the system 300 or 400 may be configured to convert NTSC video to a slower video rate. NTSC is an interlace video format having a field rate of 60*(1000/1001) Hz, which is approximately 59.94i. In this aspect, the system may convert the 59.94i rate of the NTSC video to a video rate of 50 Hz by occasionally dropping deinterlaced frames, e.g., from the deinterlacer 315. For example, if the deinterlacer 315 outputs deinterlaced frames at a rate of 59.94p, then the frame reader 320 may reduce the frame rate to 50p by routinely dropping every sixth frame (as in the case of 60 Hz to 50 Hz rate conversion) but rarely keeping the sixth frame (once every 1200 frames). In other words, the deinterlacer 315 may drop every sixth frame 199 times followed by one instance in which the deinterlacer 315 does not drop the sixth frame, and may repeat this pattern. If an interlaced video output is desired (e.g., interlaced video at 50i), then the frames at the slower rate may be interlaced by the interlacer 410 into fields at the slower rate.

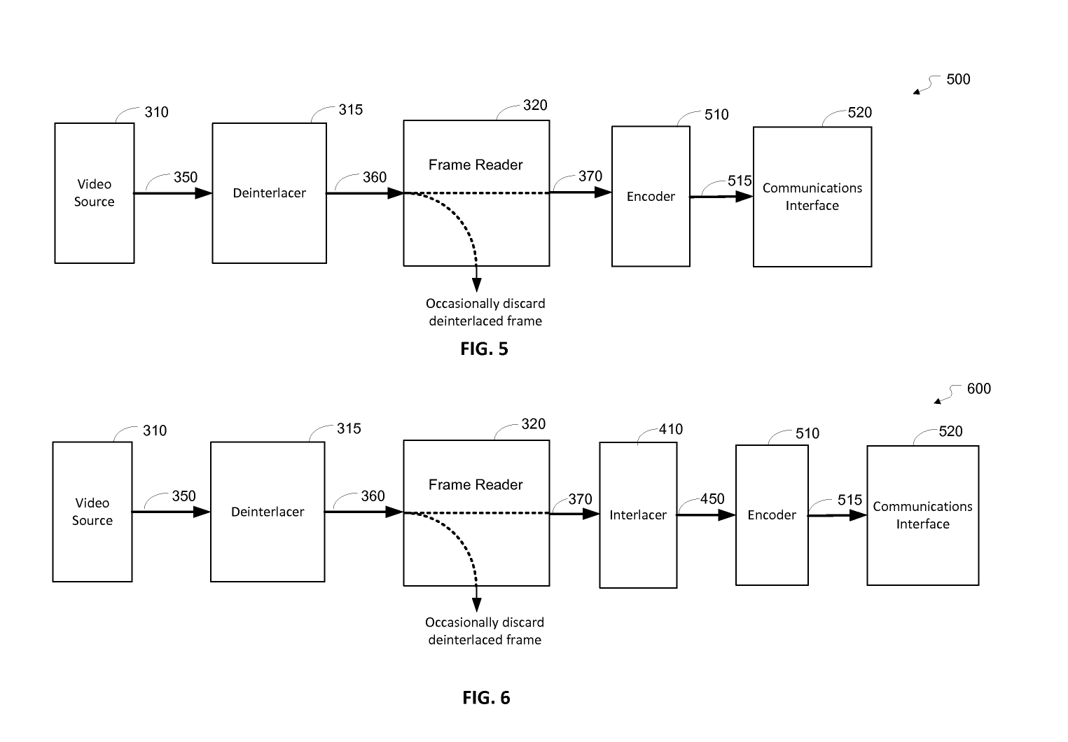

In one aspect, the slower-rate frame sequence 370 may be encoded into a video stream at the slower video rate (e.g., 50p), and transmitted to a remote device. FIG. 5 illustrates an example system 500 that includes an encoder 510 and a communications interface 520 according to an aspect of the subject technology. The encoder 510 receives the slower-rate frame sequence 370 from the frame reader 320, and encodes the frame sequence into an encoded video stream 515 at the slower video rate for transmission to a remote device via the communication interface 520. The encoding may include video compression, video scaling, etc. For example, the encoder 510 may perform video scaling to up-convert the resolution of each frame (e.g., from 480 lines of resolution to 720 lines of resolution). Thus, the system 500 may perform both rate conversion and resolution conversion, for example, to convert a 480/60i video input into a 720/50p video output.

If the video from the video source 310 is compressed, then the video may be decompressed by a decoder (not shown) before processing by the deinterlacer 315. In this case, the encoder 510 may be used to recompress the video at the slower video rate.

The communications interface 520 may include a network adapter configured to transmit the video stream over a network (e.g., the Internet), a transmitter configured to transmit the video stream over a wired connection (e.g., a cable), and/or a wireless transmitter configured to transmit the video stream via a wireless link (e.g., a WiFi link).

If an interlaced video output is desired, then the interlacer 410 may be used to convert the frames at the slower frame rate into fields before encoding. FIG. 6 illustrates an example system 600 in which the interlacer 410 converts the frames from the frame reader 320 into fields before encoding by the encoder 510. For example, if 60i to 50i conversion is desired, then the frame reader 320 may drop every sixth frame output by the deintelacer 315 to reduce the frame rate to 50p and the interlacer 410 may then convert the frames into fields at a field rate of 50i. Although the interlacer 410 and the encoder 510 are shown separately in FIG. 5 for ease of illustration, it is to be appreciated that interlacing and encoding may be performed by the same component, e.g., a processor.

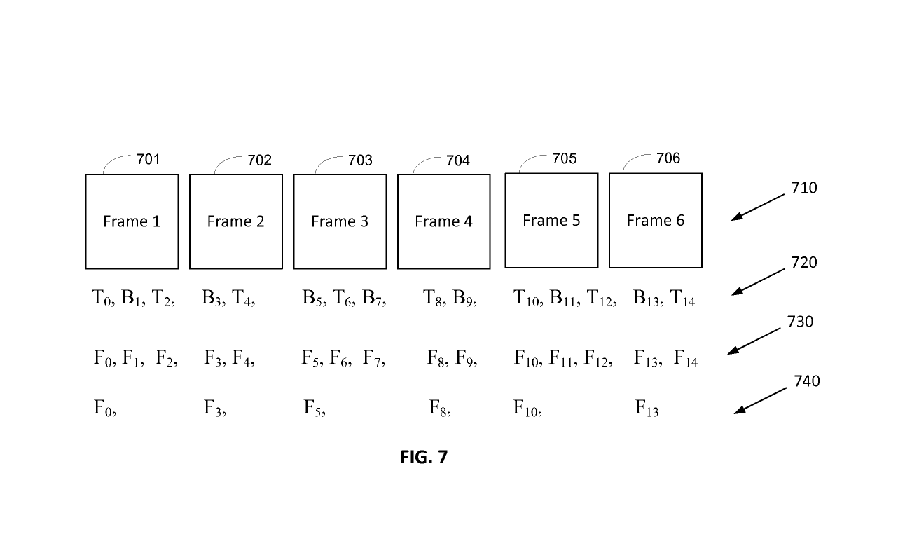

In one aspect, the subject technology may be used to convert interlaced video generated using a 3:2 pull-down process to a slower video rate. FIG. 7 shows an example of a 3:2 pull-down process for converting images captured from film into interlaced video at a field rate of 60i. The images include a sequence of film frames 710 captured at a frame rate of 24 fps. Each film frame is converted into three or two fields in an alternating pattern, resulting in a field sequence 720 having a field rate of 60i. Each field may include approximately half the image of a film frame.

The example in FIG. 7 shows six consecutive film frames 701-706 in the sequence of film frames 710. In this example, a first film frame 701 is converted into three fields (two T fields and one B field), a second film frame 702 is converted into two fields (one B field and one T field), a third film frame 703 is converted into three fields (two B fields and one T field), a fourth film frame 704 is converted into two fields (one T field and one B field), and so forth. Within each group of fields corresponding to the same film frame, two fields of the same type may be identical. For example, fields T₀ and T₂ corresponding to the first film frame 701 may be identical, in which T₂ is a repeat of T₀. The field sequence 720 may be used in an input interlaced video having a field rate of 60i and a 3:2 cadence, as shown in FIG. 7.

In one aspect, the input interlaced video may be deinterlaced using the deinterlacer 315, which operates at the rate (e.g., 60 Hz) of the input video. The deinterlacer 315 may employ a reverse 3:2 pull-down process to deinterlace the fields of the input interlaced video into a sequence of frames 730. For example, the deinterlacer 315 may deinterlace the group of fields T₀, B₁ and T₂ corresponding to the first film frame 701 into three frames F₀, F₁ and F₂, as shown in FIG. 7. Each of the frames F₀, F₁ and F₂ may be identical and may be a reproduction of the first film frame of the source film. Because the input interlaced video is input to the deinterlacer 315 without dropping fields, the 3:2 cadence of the input interlaced video is preserved, allowing the deinterlacer 315 to accurately reproduce the frames of the source film using reverse 3:2 pull-down. In the example shown in FIG. 7, the fields of the input interlaced video are deinterlaced into frames at a frame rate of 60p.

After the fields of the input interlaced video are deinterlaced into frames, the frame reader 320 may convert the deinterlaced frames to a slower video rate by selectively dropping frames in the frame sequence 730. FIG. 7 shows an example in which the frame sequence 730 is converted to a frame rate of 24p by dropping 36 frames out of every 60 frames of sequence 730. In this example, for each group of frames in the sequence 730 corresponding to the same film frame, the frame reader 320 passes one of the frames in the group while dropping the remaining frame(s). The frame dropping does not degrade image quality. This is because the frame(s) in each group that is being dropped is a repeat of the frame in the group being passed. As a result, image content is not lost.

For each group of frames in the sequence 730 corresponding to the same film frame, any one of the frames in the group may be passed while dropping the remaining frame(s). For instance, although FIG. 7 shows frame F₀ being passed, it is to be appreciated that frame reader 320 may alternatively pass either frame F₁ or F₂ while dropping the remaining frame(s) in the group. Thus, the frame reader 320 may drop frames in the sequence 730 to achieve the slower rate in such a manner that at least one frame corresponding to each film frame is passed.

FIG. 7 shows an example in which interlaced video having a field rate of 60i and generated from a source using a 3:2 pull-down process is converted to a frame rate of 24p. Thus, FIG. 7 shows an example of a 60i to 24p conversion. However, the subject technology is not limited to this example, and may be used to achieve other rate conversions. For example, the frame reader 320 may convert the output of the deinterlacer 315 to a frame rate of 50p by dropping 10 frames out of every 60 frames output by the deineterlacer 315.

If a progressive video output is desired, then the frames from the frame reader 320 may be used for the progressive video. If an interlaced video output is desired, then the frames from the frame reader 320 may be input to an interlacer, e.g., the interlacer 410, which can convert the frames into alternating T and B fields. For example, if an interlaced video output at a field rate of 50i is desired, then the frame reader 320 may convert the output of the deinterlacer 315 to a frame rate of 50p and the interlacer 410 may convert the frames from the frame reader 320 into fields at a field rate of 50i.

Although aspects of the subject technology are described above using the example of 3:2 pull-down, it is to be appreciated that the subject technology is not limited to this example, and may be used to convert interlaced video generated using, for example, a 2:2 pull-down process, an 8:8 pull-down process, a 2:3:3:2 pull-down process or other pull-down process to a slower video rate. For example, a 2:2 pull-down process may be used to convert film material into PAL video. Depending on which type of pull-down process is used to generate the input interlaced video, the deinterlacer 315 may use a corresponding reverse pull-down process (e.g., reverse 2:2 pull-down) to deinterlace the input interlaced video into frames. The frame reader 320 may then drop some of the frames from the deinterlacer 315 to achieve the desired slower video rate.

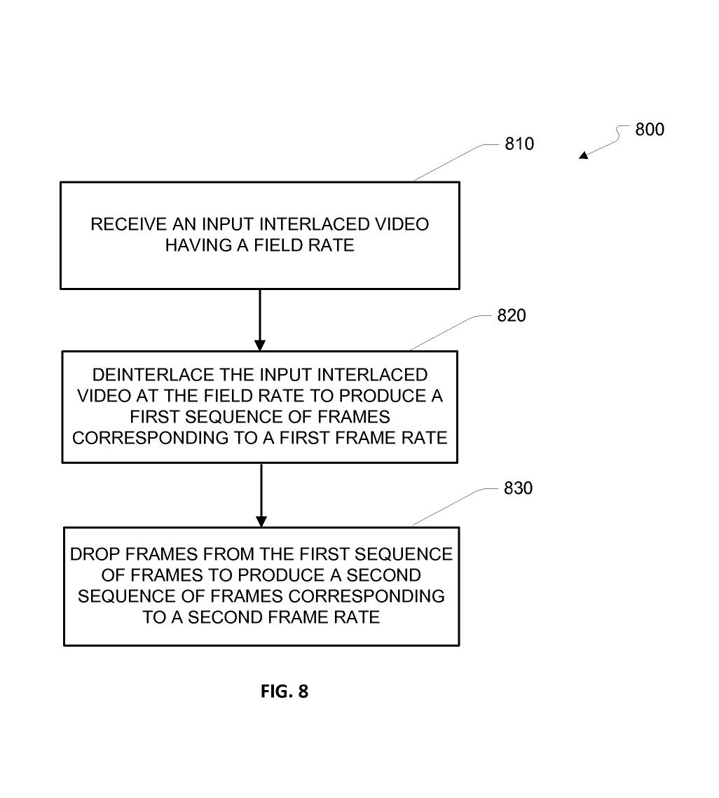

FIG. 8 illustrates a flow diagram of an example process 800 for converting an interlaced video to a slower video rate according to an aspect of the subject technology.

An input interlaced video having a field rate is received (810). The input interlaced video may be received from any of various video sources including, for example, a cable input, memory, over a network (e.g., the Internet), a wireless link, or other source. The field rate of the input interlaced video may be 60i or other field rate.

The input interlaced video is deinterlaced at the field rate to produce a first sequence of frames corresponding to a first frame rate (820). The deinterlacing may be performed by the deinterlacer 315 operating at the rate of the input interlaced video. For example, the deinterlacer 315 may operate at a rate of 60 Hz for deinterlacing an input interlaced video having a field rate of 60i.

Frames are dropped from the first sequence of frames to produce a second sequence of frames corresponding to a second frame rate, wherein the second frame rate is slower than the first frame rate (830). The dropping of frames may be performed by the frame reader 320. For example, for a 60i to 50p rate conversion, the frame reader may drop or discard every sixth frame from the first sequence of frames.

If a progressive video output is desired at the slower rate, then the second sequence of frames may be used for the progressive video output. If an interlaced video output is desired at the slower rate, then the second sequence of frames may be interlaced to produce a sequence of alternating fields (e.g., top and bottom fields) at a field rate slower than the field rate of the input interlaced video. In either case, rate conversion may occur by dropping frames (830) from the first sequence of frames produced by the deinterlacing (820).

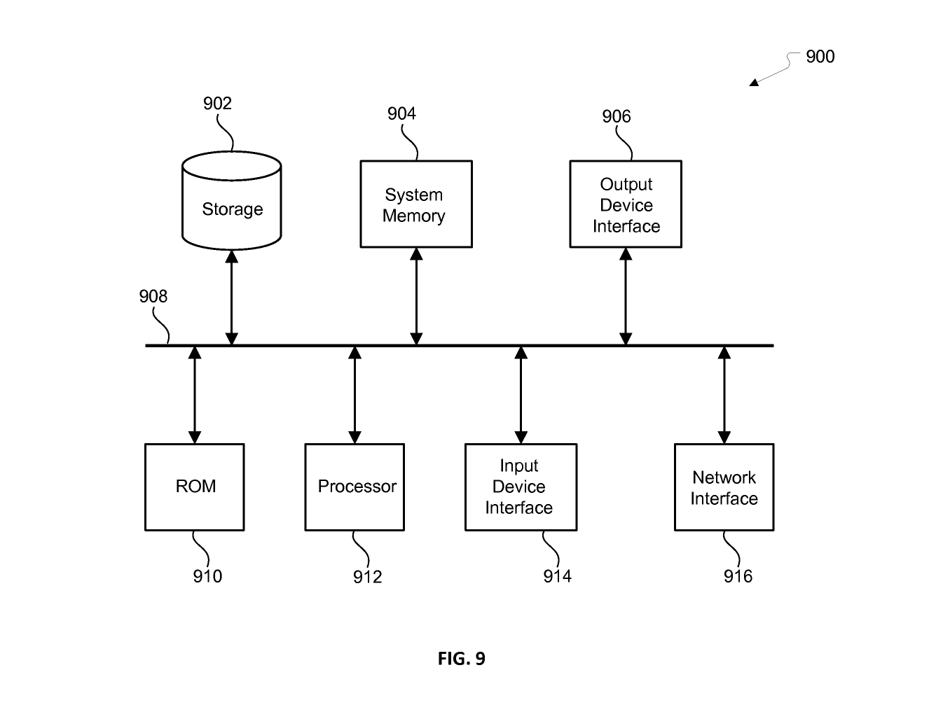

FIG. 9 conceptually illustrates an example electronic system 900 with which some implementations of the subject technology can be implemented. Electronic system 900 can be a server, a computer, a mobile communications device, a television with one or more processors embedded therein or coupled thereto, or generally any electronic device. Such an electronic system includes various types of computer readable media and interfaces for various other types of computer readable media. Electronic system 900 may include a bus 908, processing unit(s) 912, a system memory 904, a read-only memory (ROM) 910, a permanent storage device 902, an output device interface 906, an input device interface 914, and a network interface 916.

Bus 908 collectively represents all system, peripheral, and chipset buses that communicatively connect the numerous internal devices of electronic system 900. For instance, bus 908 communicatively connects processing unit(s) 912 with ROM 910, system memory 904, and permanent storage device 902. From these various memory units, processing unit(s) 912 retrieves instructions to execute and data to process in order to execute the processes of the subject disclosure. The processing unit(s) 912 can be implemented as a single processor or multiple processors in different implementations, and any processor can be implemented with one or more cores.

ROM 910 stores static data and instructions that are needed by processing unit(s) 912 and other modules of the electronic system. Permanent storage device 902, on the other hand, is a read-and-write memory device. This device is a non-volatile memory unit that stores instructions and data even when the system is turned off. Some implementations of the subject disclosure use a mass-storage device (such as a solid-state, magnetic, or optical disk drive) as permanent storage device 902.

Other implementations use a removable storage device (e.g., a flash drive, cartridge, memory module, or CD-ROM) as permanent storage device 902. Like permanent storage device 902, system memory 904 is a read-and-write memory device. However, unlike storage device 902, system memory 904 is a volatile read-and-write memory, such a random access memory. System memory 904 can store some of the instructions and/or data that the processor uses at runtime. In some implementations, the processes of the subject disclosure are stored in system memory 904, permanent storage device 902, and/or ROM 910. From these various memory units, processing unit(s) 912 retrieves instructions to execute and data to process in order to execute the processes of some implementations.

Bus 908 also connects to input and output device interfaces 914 and 906. The input device interface 914 enables a user to communicate information and select commands to the electronic system. Input devices used with input device interface 914 include, for example, alphanumeric keyboards and pointing devices (also called “cursor control devices”). The output device interfaces 906 enables, for example, the display of images generated by the electronic system 900. Output devices used with output device interface 906 include display devices, such as liquid crystal displays (LCD), light-emitting diode (LED) displays, organic LED (OLED) displays, or laser phosphor displays (LPD).

Finally, as shown in FIG. 9, bus 908 also couples electronic system 900 to a network (not shown) through a wireless or wired network interface 916, such as an antenna. In this manner, the electronic system 900 can be a part of a network of computers (such as a local area network (“LAN”), a wide area network (“WAN”), or an Intranet, or a network of networks, such as the Internet. The network interface 960 may, for example, be used to receive the input interlaced video (e.g., from the Internet). The network interface 960 may also be used to transmit the output video to a remote device (e.g., via the Internet).

Any or all components of electronic system 900 can be used in conjunction with the subject disclosure.

The functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuits. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs), programmable logic devices (PLDs), or field programmable gate arrays (FPGAs). In some implementations, such integrated circuits execute instructions that are stored on the circuit itself.

As used in this specification and any claims of this application, the terms “receiver”, “computer”, “server”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, such as an LCD, an LED display, a OLED display or a LPD, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A method for video rate conversion, comprising:
receiving an input interlaced video having a field rate, wherein the input interlaced video is generated from source film;
deinterlacing the input interlaced video at the field rate to produce a first sequence of frames corresponding to a first frame rate, wherein the first sequence of frames comprises a plurality of frame groups of varied sizes, each frame group comprising a plurality of frames corresponding to a same frame of the source film; and
dropping all but one of the frames from each of the frame groups of the first sequence of frames to produce a second sequence of frames corresponding to a second frame rate, wherein the second frame rate is slower than the first frame rate, a first frame group of the frame groups comprises a first number of frames, and a second frame group of the frame groups comprises a second number of frames that is different than the first number of frames.

2. The method of claim 1, wherein the field rate is approximately 60 fields per second, and the second frame rate is approximately 50 frames per second.

3. The method of claim 2, wherein dropping frames from the first sequence of frames comprises dropping every sixth frame from the first sequence of frames.

4. The method of claim 1, further comprising displaying the second sequence of frames on a display at the second frame rate.

5. The method of claim 1, further comprising encoding the second sequence of frames into a video stream for transmission to a remote device.

6. The method of claim 1, further comprising interlacing the second sequence of frames to produce a sequence of alternating top and bottom fields corresponding to a second field rate, wherein the second field rate is slower than the field rate of the input interlaced video.

7. The method of claim 6, wherein the second field rate is approximately 50 fields per second and the field rate of the input interlaced video is approximately 60 fields per second.

8. The method of claim 6, further comprising displaying the sequence of alternating top and bottom fields on a display at the second field rate.

9. The method of claim 6, further comprising encoding the sequence of alternating top and bottom fields into a video stream for transmission to a remote device.

10. The method of claim 1, wherein the input interlaced video is generated from the source film using a pull-down process, and deinterlacing the input interlaced video comprises deinterlacing the input interlaced video using a reverse pull-down process.

11. The method of claim 10, wherein the pull-down process comprises a 3:2 pull-down process.

12. (canceled)

13. A method for video rate conversion, comprising:
receiving an input interlaced video having a first field rate, the input interlaced video having been generated from source content;
deinterlacing the input interlaced video at the first field rate to produce a first sequence of frames corresponding to a first frame rate, wherein the first sequence of frames comprises a plurality of frame groups, each frame group comprising a plurality of frames corresponding to a same frame of the source content;
dropping all but one of the frames from each of the frame groups of the first sequence of frames to produce a second sequence of frames corresponding to a second frame rate, wherein the second frame rate is slower than the first frame rate, a first frame group of the frame groups comprises a first number of frames, and a second frame group of the frame groups comprises a second number of frames that is different than the first number of frames; and
interlacing the second sequence of frames to produce an output interlaced video having a second field rate, wherein the second field rate is slower than the first field rate.

14. A system for video rate conversion, comprising:
a deinterlacer configured to receive an input interlaced video having a field rate and to deinterlace the input interlaced video at the field rate to produce a first sequence of frames corresponding to a first frame rate, wherein the input video is generated from source content and the first sequence of frames comprises a plurality of frame groups of varied sizes, each frame group comprising a plurality of frames corresponding to a same frame of the source content; and
a frame reader configured to drop at least one of the frames in each of the frame groups of the first sequence of frames to produce a second sequence of frames corresponding to a second frame rate, wherein the second frame rate is slower than the first frame rate.

15. The system of claim 14, wherein the field rate is approximately 60 fields per second, and the second frame rate is approximately 50 frames per second.

16. The system of claim 14, further comprising an interlacer configured to interlace the second sequence of frames to produce a sequence of alternating top and bottom fields corresponding to a second field rate, wherein the second field rate is slower than the field rate of the input interlaced video.

17. The system of claim 16, wherein the second field rate is approximately 50 fields per second and the field rate of the input interlaced video is approximately 60 fields per second.

18. The system of claim 14, wherein the input interlaced video is generated from the source content using a pull-down process, and deinterlacer is configured to deinterlace the input interlaced video using a reverse pull-down process.

19. The system of claim 18, wherein the source content comprises film and the pull-down process comprises a 3:2 pull-down process.

20. The system of claim 14, wherein a first frame group of the frame groups comprises a first number of frames and a second frame group of the frame groups comprises a second number of frames that is different than the first number of frames.

21. The system of claim 14, wherein the frame reader is configured to drop all but one of the frames from each of the frame groups of the first sequence of frames to produce the second sequence of frames corresponding to the second frame rate.
